(19) United States
(12) Patent Application Publication
(10) Pub. No.: US 2003/0091220 A1
(43) Pub. Date: May 15, 2003

(54) Capacitive sensor device

(75) Inventors: Hideaki Sato, Tsurugashima (JP); Kinya Kishita, Tsurugashima (JP)

Correspondence Address: Norris, McLaughlin & Marcus P.A., 30th Floor, 220 East 42nd Street, New York, NY, 10017, US

(73) Assignee: Toko, Inc., Tokyo (JP)

(21) Appl. No.: 10/288,080

(22) Filed: Nov. 5, 2002

(30) Foreign Application Priority Data
Nov. 13, 2001 (JP) 2002-347242

(51) Int. Cl. G06K 9/00

(52) U.S. Cl. 382/124

(57) ABSTRACT

A capacitive sensor device comprises a delay circuit comprising either a sense electrode made from a material of high resistance and covered with a dielectric film or a sense electrode covered with a dielectric film and a resistor connected to the sense electrode; a reference signal source for providing input to the delay circuit; and a detector circuit for detecting delay time of output signal which is derived from the delay circuit in response to the reference signal source, wherein delay time of a signal which is produced by placing an object under detection on the dielectric film is converted to voltage in the detector circuit.

### BACKGROUND OF THE INVENTION

1. Field of the Invention

The present invention relates to a capacitive sensor device, and more particularly it pertains to such device wherein delay circuit including sense electrode is employed as sensor so that control circuit required to obtain data is simplified. The sensor device according to the present invention is suitable for detection of an object having minute ridges and valleys such for example as fingerprint.

2. Description of the Prior Art

Conventional capacitive sensor device, when applied to fingerprint sensing device for example, is arranged such that capacitance occurring between a finger and an electrode is charged by inputting power source thereto, and thereafter the capacitance, which is held by means of sample-and-hold circuit, is discharged with constant current, so that ridges and valleys of a fingerprint are detected on the basis of capacitance variation, thereby obtaining fingerprint data.

### SUMMARY OF THE INVENTION

However, such conventional system is disadvantageous in that a switch for changing over charging current and a circuit for providing control signal for the sample-and-hold circuit are separately required, which makes complex the control signal generating circuit and also makes complex and expensive the charge-discharge circuit. A further disadvantage is such that there is likelihood that mismatch due to signal delay is caused to occur among a plurality of control signal generating circuits coupled to the electrodes of the fingerprint detecting sensors, thus making it impossible to achieve accurate measurement of capacitance.

Accordingly, it is an object of the present invention to solve the abovementioned problems with the conventional capacitive sensor device and provide a novel and improved capacitive sensor device.

Briefly stated, a capacitive sensor device according to the present invention comprises a delay circuit comprising a sense electrode covered with a dielectric film, wherein the sense electrode may be either one made from a material of high resistance or one made from a material of low resistance having a resistor connected thereto; a reference signal source for providing input to the delay circuit; and a detector circuit for detecting delay time of output signal which is derived from the delay circuit in response to the reference signal source, wherein delay time of a signal generated by placing an object under detection on the dielectric film is converted to voltage in the detector circuit.

According to an embodiment of the present invention, there is provided a capacitive sensor device comprising a delay circuit comprising a sense electrode made from a material of high resistance and coated with a dielectric film, wherein the delay circuit is adapted to be established by placing an object under detection on the dielectric film; a reference signal source for providing input to the delay circuit; and a detector circuit for detecting delay time of output signal which is derived from the delay circuit in response to the reference signal source, wherein delay time of a signal generated by placing an object under detection on the dielectric film is converted to voltage in the detector circuit.

According to another embodiment of the present invention, there is provided a capacitive sensor device comprising a delay circuit comprising a sense electrode coated with a dielectric film and a resistor connected to the sense electrode, wherein the delay circuit is adapted to be established by placing an object under detection on the dielectric film; a reference signal source for providing input to the delay circuit; and a detector circuit for detecting delay time of output signal which is derived from the delay circuit in response to the reference signal source, wherein delay time of a signal generated by placing an object under detection on the dielectric film is converted to voltage in the detector circuit.

Other objects, features and advantages of the present invention will become apparent from the ensuing description taken in conjunction with the accompanying drawings.

### BRIEF DESCRIPTION OF THE DRAWINGS

FIG. 1 is a schematic view illustrating a fingerprint sensor array with a finger placed thereon.

FIG. 2 is a circuit diagram showing the sensor unit circuit of the present invention.

FIG. 3 is a timing chart illustrating voltage variations which occur during the fingerprint sensing operation of the circuit shown in FIG. 2.

FIG. 4 is a graph illustrating the relationship between the capacitance between the finger and the sensor electrode and the output voltage of detector circuit.

FIG. 5 is a block diagram of a fingerprint recognition system using the sensor device according to the present invention.

FIG. 6 is a circuit diagram of the sensor unit circuit according to a second embodiment of the present invention.

### DESCRIPTION OF THE PREFERRED EMBODIMENTS

Referring now to FIGS. 1 through 4, the capacitive sensor device according to a first embodiment of the present invention will be described as being applied to fingerprint sensing system by way of example.

The capacitive sensor device of the present invention includes a sensor array comprising a multiplicity of, two-dimensionally arranged, sense electrodes and a dielectric film overlying the sense electrodes. The sense electrodes are arranged with a spacing of 300 dpi to 500 dpi smaller than the thickness of lines represented by valleys and ridges of a fingerprint so that image of the fingerprint can be represented. The dielectric film serves to protect the sense electrodes as well as to provide capacitors between the finger and the sense electrodes.

With such sensor array, each sense electrode represents a substantially uniform capacitance, and when the finger 1 is placed on the dielectric film 2 as shown in FIG. 1, a capacitance occurs between the finger 1 and each sense electrode 3 since the finger 1 is grounded. The capacitance represents a higher magnitude at a ridge of the fingerprint, i.e., at a position where the distance between the finger and each sense electrode is shorter, while at a valley of the fingerprint, i.e., at a position where the distance between the finger and each sense electrode is longer, the capacitance represents a lower magnitude.

With the sensor electrodes 3 made from a substance of high resistance, a delay circuit is formed by the resistance of each sense electrode 3 and the capacitance occurring between the finger 1 and each sense electrode 3.

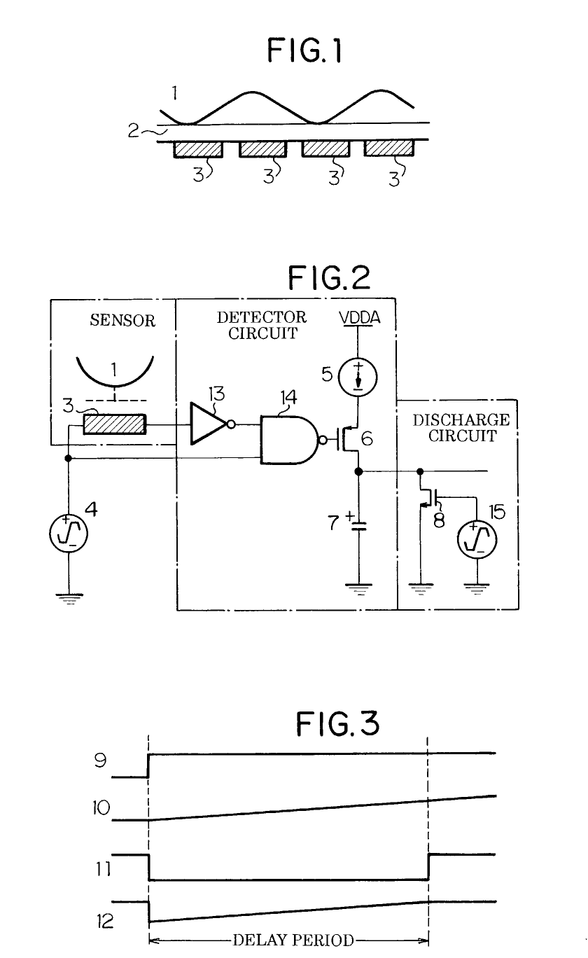

FIG. 2 shows a unit circuit representing a unit of the circuit forming the fingerprint sensing device. In such unit circuit, as shown in FIG. 2, a reference signal source 4, which applies an input signal to one end of the sense electrode 3, is connected to the delay circuit as a peripheral circuit. The opposite end of the sense electrode 3 is coupled to a detector circuit. A typical detector circuit may comprise a constant current source 5, a constant current source switch 6, and a capacitor 7. NOT circuit (inverter) 13 and NAND circuit (comparator) 14 constitutes a logical circuit as part of the detector circuit. The output of the sense electrode 3 is passed to the inverter 13 the output of which in turn is inputted to the comparator 14. Another input to the comparator 14 is provided by the reference signal source 4, the output of the comparator 14 being coupled to the gate of the constant current source switch 6.

A discharge circuit should also be provided for resetting the capacitor 7. A grounding switch 8 is connected between the constant current source switch 6 and the capacitor 7 of the detector circuit. Indicated at 15 is a signal for switching the discharge circuit.

With a finger being placed on the dielectric film of the sensor array, a fingerprint image can be produced by executing the following procedures:

The capacitor 7 is grounded via the grounding switch 8 of the discharge circuit so as to cause residual charge to be discharged. Subsequently the grounding switch 8 is turned off so that the capacitor 7 is switched from grounded state to ungrounded state. Thereafter, a pulse signal derived from the input signal source 4 is inputted to the sense electrodes. The pulse signal is delayed in a delay circuit which is formed by a capacitance occurring between the finger and the respective sense electrode as a result of the finger being placed in contact with the dielectric film, and the resistance of the sense electrode. The delay time of the pulse signal is transformed in the detector circuit to a voltage, which manifests as fingerprint data.

The delay time of the signal can be approximated by the following equation and thus is proportional to the capacitance between the finger and the sense electrode:

t=RC

where t is delay time, R is resistance value, and C is capacitance value. Further, the capacitance is in reverse proportion to the distance between the finger and the electrode since it is represented by the following equation:

C=εS/d

where C is capacitance, ε is dielectric constant, S is the area of the electrode, and d is the distance between the electrodes. Thus, it can be said that the delay time is in reverse proportion to the distance between the finger 1 and the sense electrode 3.

The detector circuit detects the time delay between the pulse signal and the signal having passed through the sense electrode 3 and holds a quantity representing the delay time. The pulse signal and the signal having passed through the sense electrode 3 are passed through the logical circuit, as a result of which the switch circuit 6 for the constant current source is closed for the delay time so that the capacitor 7 is charged from the constant current source 5. The voltage generated at the capacitor 7 is proportional to the charge stored thereat, as will be seen from the following expression:

Q=CV

where Q is electric charge, C is capacitance, and V is voltage.

With constant current, electric charge variation per unit time is constant; thus, the capacitor 7 generates a voltage proportional to delay time.

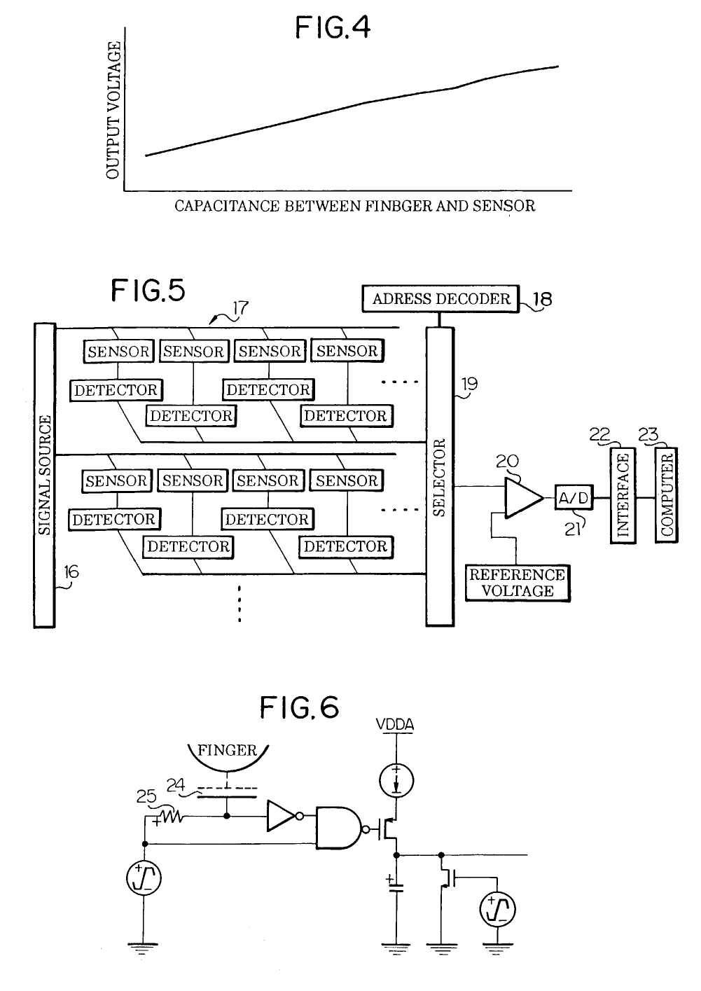

Referring to FIG. 3, there is illustrated a timing chart of the operating signal for the operation of the unit circuit described above with reference to FIG. 2. In FIG. 3, the reference numeral 9 indicates the input signal; 10 the output signal of the sense electrode 3; 11 the output of the comparator 14 or logical circuit; and 12 the potential of the capacitor 7. The input signal 9 passed to the sense electrode is delayed so that the output signal 10 occurs at the output terminal of the sense electrode. The output signal 11 of the logical circuit assumes low level momentarily when the input signal 9 rises up. The delayed signal 10 builds up gradually and goes above a predetermined threshold value, whereupon the output signal 11 of the logical circuit assumes high level. The period of time during which the signal 11 assumes low level represents the delay time, during which the capacitor 7 is charged. Thus, the voltage 12 at the capacitor 7 builds up during the charging period and after the charging is finished, is held until the capacitor 7 is discharged. As can be seen, the output voltage of the capacitor 7 represents data proportional to the capacitance produced between the finger and sense electrode. A typical result is illustrated in FIG. 4.

By using a sensor array comprising a multiplicity of said unit circuits integrated together, it is possible to construct a fingerprint recognition system as illustrated in a block diagram of FIG. 5. Output voltage of the capacitor 7 in a desired one of the detector circuits in the sensor array 7 is selected through an address decoder 18 and a selector 19. The output voltage of the capacitor 7 thus selected is amplified in an amplifier 20 and then inputted to an A/D converter 21. Data signal, converted into digital form in the A/D converter 21 is passed to a computer 23 through an interface 22. The computer 23 processes and two-dimensionally arranges data derived from the respective sense electrode elements, thereby producing a fingerprint image.

Although, in the foregoing discussion, description has been made of an example wherein the sense electrodes are made from a material of high resistance, it is also possible that in case such high resistance material cannot be used, electrode 24 made from a material of low resistance may be employed with a resistor 25 connected therewith, as illustrated in FIG. 6, thereby making it possible to produce equivalent effect. The remaining circuit arrangement may be similar to that of FIG. 2, and therefore further detailed description will be omitted. With a lower resistance value for the sense electrode or resistor, variations in the output voltage corresponding to the capacitance resulting from ridges and valleys of the fingerprint tend to be small so that there is likelihood that the accuracy of the fingerprint image will be deteriorated due to noise or the like. With a higher resistance value for the sense electrode or resistor, on the other hand, the delay time tend to be longer so that the period during which the computer is outputting data tends to be extended accordingly. Thus, a desirable resistance value for the sense electrode may be about 1 to 5 MΩ.

Furthermore, although in the above discussion the present invention has been illustrated and described as applied to a fingerprint sensing device by way of example, it will be appreciated by those skilled in the art that the present invention is not limited to fingerprint sensing but can equally be applied to test electronic components with minute ridges and valleys. It is assumed that an object whose ridge or valley is to be detected is one exhibiting conductor properties so that the object can be entirely maintained under an equal potential either by being grounded or applied with a voltage. As will be appreciated, the present invention is also applicable in an attempt to detect flaw in a metallic casing.

As will be appreciated, in accordance with the present invention, there is no need to use a control circuit for producing image signal of an object under detection when it is attempted to obtain detection data, and thus the capacitive sensor device can be simplified in terms of circuit arrangement so that the design and manufacture thereof can be facilitated.

Furthermore, by virtue of the fact that signal to be applied to the capacitive sensor device may be pulse signal alone by which even data holding can be achieved, thus making it possible to eliminate the necessity to take into consideration the delay of the pulse signal relative to other signals, so that control can be easily performed. Another advantage is such that current flowing through the delay circuit is limited by the fact that high resistance is employed for the sense electrode, which serves as an effective countermeasure for electrostatic capacitance.

While the present invention has been illustrated and described with respect to the preferred embodiments of the present invention, it is to be understood that the present invention is by no means limited thereto but encompasses all changes and modifications which will become possible within the scope of the appended claims.

What is claimed is:

1. A capacitive sensor device comprising a delay circuit comprising a sense electrode coated with a dielectric film; a reference signal source for providing input to said delay circuit; a detector circuit for detecting delay time of an output signal which is derived rom said delay circuit in response to the reference signal source, wherein the delay time of signal generated by placing an object under detection on the dielectric film is converted to voltage in said detector circuit.

2. A capacitive sensor device according to claim 1, wherein said sense electrode is made from a material of high resistance.

3. A capacitive sensor device according to claim 1, wherein said delay circuit includes a resistor connected to said sense electrode.

4. A capacitive sensor device according to claim 2, wherein said reference signal source is connected to one terminal of the sense electrode of said delay circuit; said detector circuit comprises a constant current source, a constant current source switch, and a capacitor which are connected in series with each other; another terminal of said sense electrode is connected to said constant current source switch of said detector circuit through a logical circuit; and a discharge circuit for resetting said capacitor of said detector circuit is connected between said constant current source switch and said capacitor.

5. A capacitive sensor device according to claim 3, wherein said reference signal source is connected to one terminal of said resistor of said delay circuit; said detector circuit comprises a constant current source, a constant current source switch, and a capacitor which are connected in series with each other; the opposite terminal of said resistor is connected to said constant current source switch of said detector circuit through a logical circuit; and a discharge circuit for resetting said capacitor of said detector circuit is connected between said constant current source switch and said capacitor.
